(19) United States
(12) Patent Application Publication
(10) Pub. No.: US 2010/0006081 A1
(43) Pub. Date: Jan. 14, 2010

(54) METHOD FOR MANUFACTURING SILICON MATTER FOR PLASMA PROCESSING APPARATUS

(75) Inventor: Chang Ho Choi, Gyeonggi-Do (KR)

Correspondence Address: HOSOON LEE, 9600 SW OAK ST. SUITE 525, TIGARD, OR, 97223, US

(73) Assignee: HANA SILICON, INC, Chungcheongnam-Do (KR)

(21) Appl. No.: 12/525,819

(22) PCT Filed: Aug. 2, 2007
(86) PCT No.: PCT/KR2007/003735

§ 371 Date: Aug. 5, 2009

(30) Foreign Application Priority Data
Feb. 22, 2007 (KR) 10-2007-0017983
Feb. 22, 2007 (KR) 10-2007-0017985

(51) Int. Cl. B28D 1/02; B28D 5/02; B24B 7/22; B28D 1/14

(52) U.S. Cl. 125/3; 125/12; 451/41; 451/57

(57) ABSTRACT

The present invention relates to a method for manufacturing silicon articles for a plasma processing apparatus. The present invention provides a method for manufacturing silicon articles, comprising: preparing a silicon ingot; forming a hollow silicon cylinder and a silicon core cylinder having a diameter less than that of the silicon ingot by coring the silicon ingot; forming a silicon annular plate having a central opening by cutting the hollow silicon cylinder and forming a silicon electrode plate by cutting the silicon core cylinder; and forming a silicon ring by processing the silicon annular plate and forming a silicon electrode by processing the silicon electrode plate. According to the present invention, a hollow silicon cylinder and a silicon core cylinder are manufactured by coring a cylindrical silicon ingot before the silicon ingot is sliced. They are used to manufacture silicon articles, such as a silicon ring and a silicon electrode, so that the production cost for the silicon articles can be reduced.

### TECHNICAL FIELD

The present invention relates to a method for manufacturing silicon articles for a plasma processing apparatus, and more particularly, to a method for manufacturing silicon articles for a plasma processing apparatus, in which a silicon ring (i.e., a focus ring) and a silicon electrode plate used in a plasma processing apparatus are manufactured using one piece of a single crystal silicon ingot to thereby reduce production cost for silicon rings and silicon electrode plates.

### BACKGROUND ART

In general, a semiconductor device is manufactured by forming a semiconductor thin film, a conductive thin film or an insulation thin film on a semiconductor substrate (i.e., a silicon wafer) and then selectively etching the thin films. In recent years, a plasma technique has been used in a process of forming a thin film and a process of etching to improve process efficiency. For example, in a case of an etching process, a reaction gas is supplied into a plasma etching chamber, and then high-frequency electric power is applied to the chamber to excite the reaction gas into plasma state. In this way, the reaction gas is plasmarized to enhance reactivity with the thin films on the wafer, and also the thin film is removed by physical collision of the plasmarized reaction gas to improve the thin film removal ability.

A plasma processing apparatus includes a lower electrode where a wafer is placed, a silicon ring provided in an edge area of the wafer, and an upper electrode provided above the lower electrode to function as a shower head. Here, the silicon ring and the upper electrode are formed of a silicon material.

In particular, plasma formed above the wafer should be uniformly distributed, which is a problem in the plasma processing apparatus. Thus, a circular ring is positioned near the edge of the wafer to improve the uniformity of the plasma distribution on the wafer. That is, the plasma is expanded beyond the wafer to improve uniformity of the plasma over the wafer.

A method for manufacturing such a conventional silicon ring will be briefly described as follows.

A circular silicon plate is manufactured by cutting a silicon ingot. Then, a central hole is formed in the center of the circular silicon plate. A rotary grinder or the like is used to grind the surface of the silicon plate. Thereafter, it is polished using a single-sided polishing method of a single wafer type to form a silicon ring. At this time, a portion of the silicon plate, which is cut off to form the central hole, is discarded.

In addition, a method for manufacturing the conventional upper electrode will be briefly described as follows.

A circular silicon plate is manufactured by cutting a silicon ingot. A plurality of through-holes are formed uniformly on the circular silicon plate. Thereafter, a grinder or the like is used to grind the silicon plate having the plurality of through-holes, and the silicon plate is then polished through a single-sided polishing method to finish a silicon upper electrode.

As described above, with the conventional process for manufacturing a silicon ring and a silicon electrode plate used in the plasma processing apparatus, a large amount of single crystal silicon is discarded to thereby result in an increase in the production cost.

Since the polishing after grinding is single-sided polishing of a single wafer type using a wax process, the resultant silicon ring has a degraded surface flatness and also the production efficiency is lowered. In addition, the uneven surface of a silicon ring leads to a particle source, and thus a larger amount of particles compared with the wafer is produced during the etching process. Furthermore, a silicon ring manufactured through the above conventional method has a kerf loss of above 1 mm to increase the production cost.

### DISCLOSURE OF INVENTION

### Technical Problem

The present invention for solving the aforementioned problems is to provide a method for manufacturing a silicon ring, wherein a single crystal silicon ingot is cored to manufacture a silicon cylinder for manufacturing a silicon ring and a central portion of the silicon ingot cut off by the coring, i.e., a silicon core cylinder, is used for manufacturing a silicon electrode, thereby reducing the production cost, a surface of the silicon ring and the silicon electrode has a mirror surface similar to that of a wafer to reduce particle sources, and a kerf loss can be reduced to 1 mm or less to thereby lower the production cost.

### Technical Solution

According to an aspect of the present invention, there is provided a method for manufacturing silicon articles, comprising: preparing a silicon ingot; coring the silicon ingot to form a hollow silicon cylinder and a silicon core cylinder having a diameter less than that of the silicon ingot; cutting the hollow silicon cylinder to form a silicon annular plate having a central opening and cutting the silicon core cylinder to form a silicon electrode plate; and processing the silicon annular plate to form a silicon ring and processing the silicon electrode plate to form a silicon electrode.

The method may further include removing a portion of both ends of the silicon ingot through a cropping process after preparing the silicon ingot.

The method may further include processing an outer circumference of the silicon ingot through a rod grinding process after preparing the silicon ingot.

The coring process may be performed in such a way that a carbon jig is bonded to a top surface, a bottom surface, or both the top and bottom surfaces of the silicon ingot and a portion of the center of the silicon ingot to which the carbon jig is bonded is removed.

The method may further include cutting the silicon ingot into a plurality of blocks before coring the silicon ingot.

Processing the silicon electrode plate to form a silicon electrode may include: processing the silicon electrode plate to form a plurality of through-holes therein; and polishing surfaces of the silicon electrode plate having the through-holes.

The through-hole may be bored using a drill or ultrasonic wave. The silicon electrode plate may be divided into a plurality of regions and the boring process is performed for each region. The method may further include processing the outer surface of the silicon electrode plate to adjust size thereof before or after forming the plurality of through-holes.

The method may further include manufacturing a silicon electrode body by removing a portion of the silicon electrode plate before forming the plurality of through-holes. The method may further include combining the silicon electrode bodies to manufacture the silicon electrode.

The method may further include controlling resistance of the silicon electrode plate through a heat treatment process. The method may further include grinding the top and bottom surfaces of the silicon electrode plate simultaneously using a double-sided grinder after forming the plurality of through-holes. A double-sided polishing process for polishing the top and bottom surfaces of the silicon electrode plate simultaneously may be used when polishing the surfaces.

According to another aspect of the present invention, there is provided a method for manufacturing silicon articles, comprising: preparing a silicon cylinder; forming a through-hole in the center of the silicon cylinder through a coring process; cutting the silicon cylinder to form a silicon annular plate having a central opening; processing outer and inner surfaces of the silicon annular plate to form a silicon ring member; and polishing the surfaces of the silicon ring member.

Preparing the silicon cylinder may include: growing a single crystal silicon ingot; removing a portion of both ends of the single crystal silicon ingot using a cropping process; and processing an outer circumference of the single crystal silicon ingot using a rod grinding process.

The coring process may include: bonding a carbon jig to a top surface, a bottom surface, or the top and bottom surfaces of the silicon cylinder; coring the silicon cylinder, to which the carbon jig is bonded, to partially remove a central portion of the silicon cylinder; and removing the carbon jig and impurities generated while coring the silicon cylinder. A double-sided polishing process for polishing the top and bottom surfaces of the silicon ring member simultaneously may be used when polishing the surfaces.

According to a further aspect of the present invention, there is provided a method for manufacturing silicon articles, comprising: preparing a silicon ingot; forming a through-hole in a central portion of the silicon ingot; and forming a silicon ring member by cutting the silicon ingot having the through-hole.

The method may further include processing and polishing the silicon ring member.

### ADVANTAGEOUS EFFECTS

As described above, according to the present invention, a cylindrical silicon ingot is cored to manufacture a hollow silicon cylinder and a silicon core cylinder, before the silicon ingot is sliced. They are used to manufacture silicon articles, such as a silicon ring and a silicon electrode, thereby enabling reduction of production cost for the silicon articles.

Further, in the present invention, surface characteristics of the silicon ring and the silicon electrode are made to be similar to those of a wafer, thereby enabling improvement of plasma uniformity over the wafer.

In addition, according to the present invention, the silicon ring and the silicon electrode can be processed to have a kerf loss of 1 mm or less, thereby reducing the production cost.

The present invention is not limited to the embodiments disclosed above but may be implemented into different forms. These embodiments are provided only for illustrative purposes and for full understanding of the scope of the present invention by those skilled in the art. The scope of the invention is defined by the appended claims.

### BRIEF DESCRIPTION OF THE DRAWINGS

FIG. 1 is a flowchart illustrating a method for manufacturing silicon articles according to an embodiment of the invention;

FIGS. 2 to 9 are views illustrating the method for manufacturing silicon articles according to the embodiment;

FIGS. 10 and 11 are views illustrating a method for manufacturing a silicon electrode according to a variant of the embodiment;

FIG. 12 is a flowchart illustrating a coring process according to the embodiment;

FIG. 13 is a flowchart illustrating a polishing process according to the embodiment; and

FIG. 14 is a schematic sectional view of a plasma etching apparatus in which the silicon articles manufactured according to the embodiment is employed.

### BEST MODE FOR CARRYING OUT THE INVENTION

Hereinafter, exemplary embodiments of the present invention will be described in detail with reference to the accompanying drawings. However, the present invention is not limited to the embodiments disclosed below but may be implemented into different forms. These embodiments are provided only for illustrative purposes and for full understanding of the scope of the present invention by those skilled in the art. Throughout the drawings, like reference numerals are used to designate like elements.

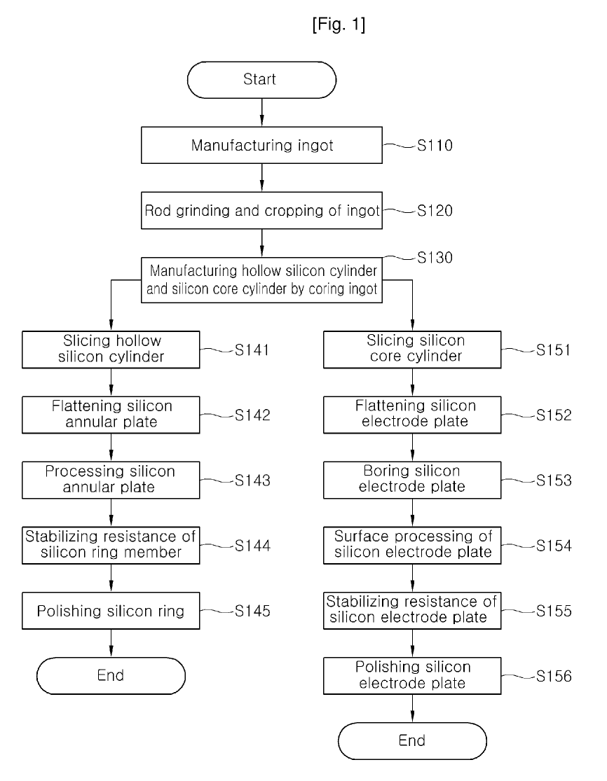

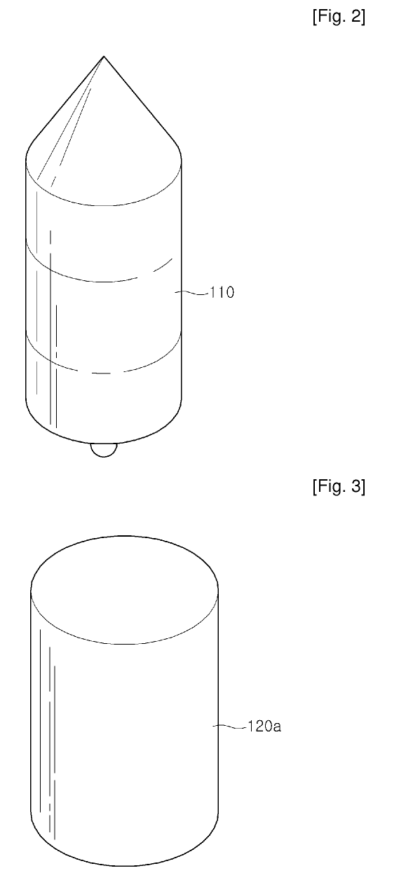

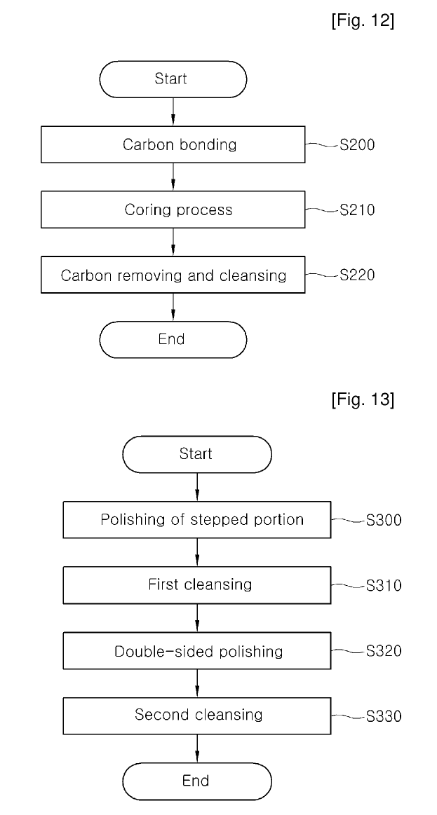

FIG. 1 is a flowchart illustrating a method for manufacturing silicon articles according to an embodiment of the invention. FIGS. 2 to 9 are views illustrating the method for manufacturing silicon articles according to the embodiment. FIGS. 10 and 11 are views illustrating a method for manufacturing a silicon electrode according to a variant of the embodiment. FIG. 12 is a flowchart illustrating a coring process according to the embodiment, and FIG. 13 is a flowchart illustrating a polishing process according to the embodiment.

Hereinafter, a description will be given with reference to FIGS. 2 to 9 based on the flowchart of FIG. 1.

First, as shown in FIG. 2, an ingot 110 having a large diameter (8 inches or more) is manufactured (S110). The ingot 110 may be grown through a Czochralski (CZ) method. Of course, the present invention is not limited thereto. That is, a large diameter ingot may be grown through a variety of processes, for example, a float zone (FZ) method.

In manufacturing the ingot 110, first of all, raw materials including poly silicon are charged inside a quartz crucible, and then, the crucible is heated up. The crucible is heated to about 1,412 C or more to melt the raw materials inside the crucible. The crucible be heated up to 1,400 to 1,500 C to melt the raw materials. Thereafter, a single crystal seed, which has the same crystal orientation as a target crystal orientation, is brought into contact with the central area of the melt surface. The seed is slowly lifted up to grow the single crystal silicon ingot 110. At this time, the seed and the quartz crucible are rotated in opposite directions to each other. When the seed is lifted upwardly from the melt, surface tension is generated between the seed and the melt surface. Due to the surface tension, the silicon melt continues to adhere to the seed surface, and simultaneously the silicon melt is cooled. While the silicon melt is being cooled on the seed surface, silicon atoms in the melt come to have the same crystal orientation as the seed.

Here, for the purpose of smooth flow and stabilization of the melt, a magnetic field may be applied to the ingot manufacturing apparatus. In this embodiment, a horizontal magnetic field may be applied thereto in order to grow a large area ingot. The horizontal magnetic field means a magnetic field applied perpendicular to the growth direction of the ingot. As the horizontal magnetic field, a magnetic field of 1,000 gauss or higher is employed.

As shown in FIG. 3, upper and lower unnecessary portions of the single crystal ingot are cut off through a cropping process, whereby the ingot 110 is manufactured to have a cylindrical shape (S120). That is, as shown in FIG. 2, the single crystal ingot 110 grown through a Czochralski (CZ) method has a barrel shape having upper and lower pointed protrusions. Thus, a cropping process is performed to cut off the upper and lower protrusions, so that a single crystal silicon cylinder 120a is obtained. This makes subsequent processes easy.

At this time, the single crystal ingot may be cut into a plurality of blocks. In addition, the cropping process may be omitted if needed.

Thereafter, a rod grinding process is performed to process the outer surface of the ingot 110 to adjust an outer diameter. At this time, the ingot 110 may have an outer diameter similar to that of the silicon ring to be manufactured. In this embodiment, the ingot 110 is manufactured to have an outer diameter larger than that of a target silicon ring, considering thickness to be removed by subsequent polishing and grinding processes. For example, when the maximum outer diameter of the silicon ring is 1, the outer diameter of the cylindrical ingot 110 (i.e., the single crystal silicon cylinder 120a) may be in a range of 1.01 to 1.10. At this time, when the ratio is out of this range, it may be difficult to control process conditions of grinding and polishing. The rod grinding process may be omitted if needed. When the rod grinding process is omitted, outer diameter machining can be performed using a computer numerical control (CNC) facility in the subsequent process.

After the rod grinding process, quality of the single crystal silicon cylinder 120a is inspected. Through this quality inspection, the outer diameter evaluation, edge chip evaluation and the like of the single crystal silicon cylinder 120a are performed.

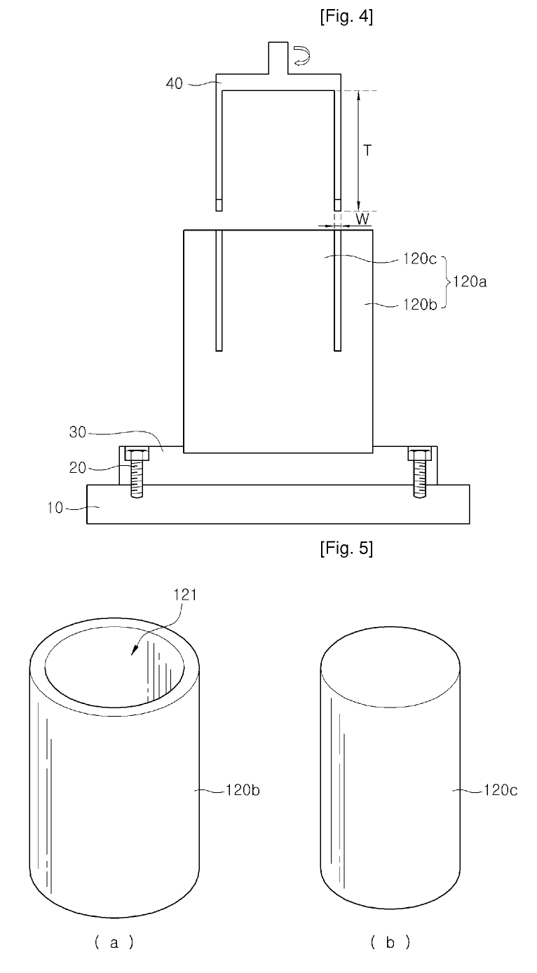

As shown in FIGS. 4 and 5, a hollow silicon cylinder 120b and a silicon core cylinder 120c are manufactured through a coring process (S130).

FIG. 4 is a sectional view illustrating the coring process, FIG. 5(a) is a perspective view of a hollow silicon cylinder after the coring process, and FIG. 5(b) is a perspective view of a silicon core cylinder after the coring process.

In this embodiment, the single crystal silicon cylinder 120a is cored, whereby the hollow silicon cylinder 120b for manufacturing a silicon ring and the silicon core cylinder 120c for manufacturing a silicon electrode are made simultaneously.

Diameters of the silicon core cylinder 120c and a through-hole 121 of the hollow silicon cylinder 120b, which are manufactured through the coring process, may be adjusted depending on the inner diameter of a silicon ring to be manufactured. The silicon ring may have a plurality of inner diameters different from one another. Thus, the diameter of the through-hole 121 may have a similar value to the minimum inner diameter of a silicon ring to be manufactured. That is, when the minimum inner diameter of the silicon ring is 1, the diameter of the through-hole 121 of the hollow silicon cylinder 120b may be in a range of 0.90 to 0.99. This is because the inner diameter may be partially increased during the subsequent grinding and inner diameter polishing processes. In addition, when the ratio is out of this range, it can be difficult to control conditions for grinding and polishing processes. The through-hole 121 is formed in the growth direction of the ingot, i.e., in parallel with the longitudinal direction of the single crystal silicon cylinder 120a. Further, the diameter of the silicon core cylinder 120c is about 0.1 to 10% less than that of the through-hole 121, since because there is a portion removed by the coring process.

Hereinafter, the coring process will be described in greater detail with reference to FIGS. 4 and 12.

After completion of the cropping and rod grinding processes and inspection, a carbon jig 30 is bonded to the lower and/or upper surface of the single crystal silicon cylinder 120a (S200). As shown in FIG. 4, the carbon jig 30 is attached to the lower surface of the silicon cylinder 120a. The carbon jig 30 has a generally tetragonal plate shape. The carbon jig 30 is fixed on a stage 10 of a coring processing apparatus, using a fixing member 20. In this way, the carbon jig 30 is attached to the silicon cylinder 120a to thereby freely move the silicon cylinder 120a when in the cording process. In addition, since the single crystal silicon cylinder 120a can be fixed to the coring apparatus, the coring process can be easily carried out.

Then, the coring process is performed to remove a portion of the inner center of the carbon-bonded silicon cylinder 120a (S210).

As shown in FIG. 4, the coring process is performed in such a way to rotate a coring wheel 40, at the end of which a cutting member (e.g., a diamond cutting element) having a circular annular shape is provided. The rotating coring wheel 40 is lowered toward the single crystal silicon cylinder 120a. In this way, as shown in FIG. 4, a portion of the single crystal silicon in the inner center of the silicon cylinder 120a is removed by the rotation of the cutting member at the end of the rotating coring wheel 40 in order to produce the hollow silicon cylinder 120b and the silicon core cylinder 120c having a diameter less than the ingot. In FIG. 4, a length T of the coring wheel 40 may vary with the silicon cylinder 120a. A thickness W (or a width) of the coring wheel 40 (specifically, the cutting member) may be in a range of 0.1 to 5 mm. An amount of silicon removed from the silicon cylinder 120a is increased when the thickness W of the cutting member is increased. In addition, when the thickness W of the cutting member is decreased, the strength of the cutting member is decreased, which may lead to difficult handling of the coring wheel 40.

When the coring process is carried out, the carbon jig 30 provided in the lower side of the silicon cylinder 120a is also partially removed. In addition, a cutting process may be carried out to cut the silicon cylinder 120a into a plurality of blocks before the coring process, and then the coring process may be performed for each silicon block. The coring process may be performed at one time from the top to the bottom of the silicon cylinder 120a. Of course, the coring is not limited to the above embodiments. That is, for example, after a primary coring is carried out towards the lower side from the top of the silicon cylinder 120a, the silicon cylinder 120a may be turned upside down to perform a secondary coring towards the upper side from the bottom of the silicon cylinder 120a. That is, the coring process can be performed in various ways depending on a length of the silicon cylinder 120a (or the silicon block) and a length of the coring wheel 40.

After the hollow silicon cylinder 120b and the silicon core cylinder 120c are manufactured through the coring process, a carbon removing process is carried out to remove the carbon jig 30 bonded to the hollow silicon cylinder 120b and the silicon core cylinder 120c (S220). Then, a cleansing process is performed to remove particles and foreign materials generated during the coring process. At this time, the carbon removing and cleansing processes can be carried out simultaneously as a single process.

In this way, according to this embodiment, in an ingot state before slicing (i.e., in a silicon cylinder 120a state), the internal through-hole 121 is formed in the center in order to manufacture a ring, and thereby the production cost is reduced. In addition, the silicon core cylinder of the central portion of the ingot being formed by the coring process can be re-cycled, and thereby the production cost of the silicon articles can be further reduced. That is, according to a conventional art, an ingot is sliced into a plurality of disks, and then, each disk is cored to form a through-hole in the center thereof. For example, in a case where a single ingot (i.e., a silicon cylinder) is sliced into one hundred silicon disks, the coring process must be performed for each of the one hundred silicon disks. That is, the coring process must be carried out one hundred times. In this embodiment, however, since the coring process is carried out on the silicon cylinder 120a before slicing, a single coring process can replace one hundred times of the disk coring process. Thus, the number of coring processes can be significantly reduced, as compared with a conventional art.

Furthermore, since a thin disk is conventionally used, a central portion (i.e., a silicon core cylinder) of the disk, which is cut out through the coring process, is discarded. In this embodiment, however, the central portion of the silicon cylinder 120 cut out by the coring process becomes the silicon core cylinder having a smaller diameter, and the silicon core cylinder can be re-cycled for other purposes. For example, it can be used as silicon wafers, silicon electrodes or silicon rings of smaller size. In this embodiment, the silicon core cylinder is used to manufacture silicon electrodes.

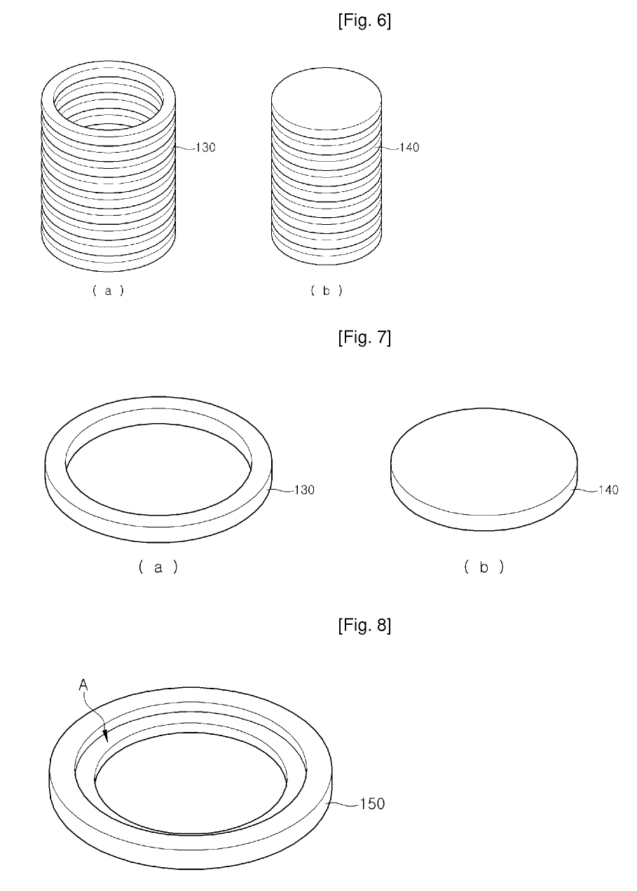

As shown in FIG. 6, the hollow silicon cylinder 120b (having a circular through-hole 121 provided in the center thereof) formed through the coring process is sliced into silicon annular plates 130 having an opening in the center thereof, and the silicon core cylinder 120c is sliced to form silicon electrode plates (S141, S151).

The hollow silicon cylinder 120b and the silicon core cylinder 120c are sliced through a wire sawing process, so that the silicon annular plates 130 and the silicon electrode plates 140 are manufactured. Of course, the slicing process is not limited thereto, but a diamond cutting process can be employed. In this embodiment, the thickness of the silicon annular plates 130 and the silicon electrode plates 140 can be controlled in various ways to manufacture various types of silicon rings and silicon electrodes. That is, in conventional art, a plurality of disks have the same thickness and thus cannot be easily applied to various types of products. In this embodiment, however, thickness control is possible when the hollow silicon cylinder 120b and the silicon core cylinder 120c are sliced, and thereby the silicon annular plates 130 and the silicon electrode plates 140 having different thicknesses can be manufactured.

That is, the single hollow silicon cylinder 120 and the single silicon core cylinder 120c can be made not only into silicon annular plates 130 and silicon electrode plates 140 having the same thickness, but also into silicon annular plates 130 and silicon electrode plates 140 having different thicknesses. In addition, as in the aforementioned coring process, the carbon jig may be bonded to the outer circumferential surface of the silicon cylinder before the slicing process for manufacturing the silicon annular plates 130.

As shown in FIG. 7, a flattening process is carried out to flatten the surface of the silicon annular plate 130 and the surface of the silicon electrode plate 140 (S142, S152).

The top and bottom surfaces of the silicon annular plate 130 and the silicon electrode plate 140, which have been wire-sliced, are flattened through a grinding process. The above flattening process includes a grinding process using a grinder. That is, the grinding process can be used to remove a saw-mark caused by means of the sawing process and to improve the surface flatness. Here, in case of the silicon annular plate 130, the inner and outer surfaces may be ground together.

The grinding process may be performed using a dual-shaft grinder which can be equipped with a rough grinding wheel and a fine grinding wheel. The rough grinding wheel may be a 200 to 400 mesh grinding wheel and the fine grinding wheel may be a 1,000 to 3,000 mesh grinding wheel.

At this time, the grinding process using a rough grinding wheel removes wire saw marks and improves flatness, and the grinding process using a fine grinding wheel reduces the surface roughness to enable subsequent processes to be carried out with ease. Of course, the grinding process is not limited thereto, but may performed using various other grinders used in a wafer processing. After the grinding process, a cleansing process may be further carried out in order to remove particles and sludge generated during the grinding process. The cleansing process for removing impurities may employ a double scrubber process. That is, a double scrubber apparatus having brushes at upper and lower areas thereof can be used to remove impurities on the top and bottom surfaces of the silicon annular plate 130 and the silicon electrode plate 140 simultaneously.

After the grinding process, an etching process is performed in order to remove grinding damage. As the etching process, a wet etching process is performed. Alkaline chemicals including KOH and/or NaOH may be used as a chemical etchant for wet etching. Of course, acid chemicals such as HNO₃ may also be used.

Hereinafter, manufacturing a silicon ring and a silicon electrode will be described based on the sliced silicon annular plate 130 and silicon electrode plate 140. First, a method of manufacturing a silicon ring using the silicon annular plate 130 with the center thereof open will be described.

As shown in FIG. 8, the inner wall surface and/or the outer wall surface of the silicon annular plate 130 is processed to manufacture a silicon ring member 150 (S143).

Various types of processing may be carried out, depending on applications of the silicon ring. In this embodiment, a portion of the inner wall surface is removed to form a silicon ring member 150 having a stepped portion (designated by A in FIG. 8). That is, the silicon ring member 150 includes a through-hole of a first diameter in the center thereof and a groove having a second diameter larger than the first diameter. Of course, the present invention is not limited thereto, but may be implemented in various other ways, including an extended protrusion or a concave groove, if required.

In case of the silicon annular plate 130 having a central opening, the inner and outer surfaces thereof may be machined through a grinding process. At this time, the silicon annular plate 130 may be machined using a CNC apparatus or an MCT (machining center tool) apparatus.

Further, after the machining process, a cleansing process may be carried out in order to remove particles and sludge generated during the machining process. After the machining process, the manufactured silicon ring member 140 may be inspected for defects.

After the machining process, an etching process is performed in order to remove damage caused by the machining process. The etching process is carried out using alkaline chemicals including KOH and/or NaOH, or acid chemicals such as HNO₃. After the etching process, a cleansing process using DI or SCI (NH₄O+H₂O₂+H₂O) may be carried out to remove impurities and chemicals adhered to the surface of the silicon ring member 150. The etching and cleansing processes after the machining process may be performed in a clean room in which fine dusts are not generated. This is because subsequent processes are carried out in a clean room. Of course, the etching and cleansing processes may be carried out in an ordinary room.

Thereafter, a donor killing process is performed to stabilize resistance of the silicon ring member 150 (S144).

That is, the donor killing process removes dopant inside the silicon ring member 150 through a heat treatment. The heat treatment may be performed using a heat treatment apparatus such as a furnace type, oven type or a belt type. In addition, the heat treatment is performed at 400 C or more. The heat treatment is performed in a range of 400 to 1,000 C. At this time, contamination of the silicon ring member 150 may be prevented by precluding impurities during heat treatment.

After stabilizing resistance of the silicon ring member 150 through the donor killing process, the resistance of the silicon ring member 150 is measured. A laser marking is carried out in order to manage the history of the silicon ring.

Then, a polishing process is carried out to flatten the outer surface of the silicon ring member 150 and reduce the surface roughness thereof to manufacture a silicon ring (S145).

The polishing process is explained with reference to FIG. 13.

In the polishing process, first, the stepped portion of the silicon ring member 150 is polished through a step polishing process (S300). Through this process, flatness of the stepped portion can be improved and a surface roughness can be 5 or less. That is, the inner surface and stepped surface (the through-hole and groove regions) of the silicon ring member 150 are polished. Then, a cleansing process is performed (S310).

After the cleansing process, the top and bottom surfaces of the silicon ring member 150 are polished at the same time through a double-sided polishing process (S320).

The double-sided polishing apparatus includes a lower polishing pad portion, an upper polishing pad portion, and a plurality of carriers between the lower and upper polishing pad portions, each of the carriers having a predetermined through-hole in which the silicon ring member 150 is positioned to prevent the silicon ring member from escaping. At this time, the lower and upper polishing pads are rotated in opposite directions to polish the top and bottom surfaces of the silicon ring member 150 simultaneously. In addition, the plurality of carriers may rotate together.

In the double-sided polishing apparatus, only the carriers are changed to perform polishing regardless of the size and thickness of the silicon ring member 150, thereby polishing process may be easy. In addition, the surface roughness of the top and bottom surfaces of the silicon ring member 150 can be controlled by controlling slurry and surfactant being injected during the polishing process. That is, a general polishing process is a single-sided polishing process, in which one side of a silicon plate is coated with wax and then bonded to a polishing head. Accordingly, the flatness may vary according to the uniformity of the wax coating. In a double-sided polishing process, however, no wax coating process is carried out. This is because a carrier is manufactured so as to match with the thickness of the silicon ring member 150 to be processed, and a carrier hole is formed to fit into the size of silicon ring products.

Through the double-sided polishing process, the flatness of the top and bottom surfaces of the silicon ring member 150 can be enhanced and the surface roughness can be maintained 5 Å or less. The surface roughness thereof is maintained in a range of 1 to 5 Å and thus can be similar to that of a silicon wafer of 2 Å. In this way, the surface roughness of the silicon ring can be made similar to that of a silicon wafer, thereby increasing plasma uniformity over a wafer to improve the plasma processing efficiency.

After the double-sided polishing process, a cleansing process is performed to remove slurry and particles (S330). In this way, the silicon ring according to this embodiment is manufactured.

Thereafter, a dimension of the completed silicon ring is measured and then a final cleansing is performed. 3D inspection may be carried out for measuring the dimension of the silicon ring. In addition, after the final cleansing, a visual inspection is carried out. As the visual inspection, a surface inspection and an edge chipping inspection are performed, and thereby particles and deep scratches can be inspected.

Hereinafter, a method for manufacturing a silicon electrode using the silicon electrode plate will be described. Here, similar descriptions to the silicon ring will be omitted.

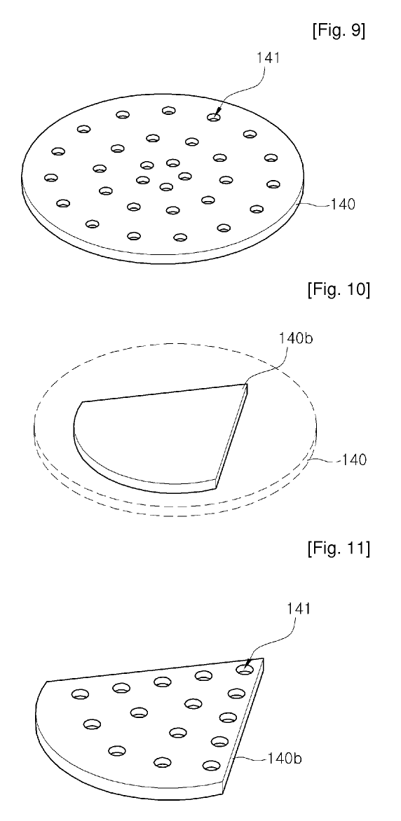

As shown in FIG. 9, a boring process is performed to form a plurality of through-holes 141 in the silicon electrode plate 140 (S153).

Before boring the holes, the outer diameter of the silicon electrode plate 140 may be ground to conform to standard dimension. Since the outer diameter of the silicon core cylinder 120c, which is manufactured through the previous coring process, is determined by the silicon ring, the outer diameter of the silicon electrode plate may be processed again to conform to a desired outer diameter, i.e., the standard dimension. Of course, grinding the outer diameter of the silicon electrode plate 140 may be performed for the silicon core cylinder 120c after the coring process. A CNC apparatus may be used to machine the outer diameter of the silicon electrode plate 140. Furthermore, after machining the outer diameter, the silicon electrode plate 140 may be cleansed and inspected.

After machining the outer diameter of the silicon electrode plate 140, the silicon electrode plate 140 is bonded to a base plate of a boring apparatus. That is, the silicon electrode plate 140 is bonded to the base plate for boring the holes. Then, a drill or ultrasonic boring process is employed to form the plurality of through-holes 141. Here, through the ultrasonic boring process, hundreds of holes are bored at a time, thereby production efficiency can be improved. In addition, through the boring process, the holes can be formed entirely over the silicon electrode plate 140. Of course, if the silicon electrode plate 140 has a large diameter, the silicon electrode plate 140 can be divided into multiple regions and then the boring process can be carried out for the respective regions.

After the boring process, the base plate bonded to the silicon electrode plate 140 is removed and the silicon electrode plate 140 is cleansed. The circularity and concentricity of the through-hole 141 are inspected with the naked eye or with a tool such as a microscope and vision. A double-sided sliding process is carried out to remove hole-chipping generated on the top and bottom surfaces of the silicon electrode plate 140. At this time, the double-sided sliding process is carried out using a double-sided grinder (S154). Here, the double-sided grinder has at least two shafts, wherein a rough grinding is performed by means of at least one shaft and a fine grinding is performed by means of the other(s) thereof. In this way, the surface roughness of the top and bottom surfaces of the silicon electrode plate 140 can be improved. Here, the rough grinding represents 200 to 1,000 mesh, and the fine grinding represents 1,000 to 3,000 mesh. The rough grinding may represent 250 to 400 mesh and the fine grinding may represent 1,500 to 2,500 mesh.

After the double-sided sliding process, a cleansing process is performed. At this time, a double scrubber can be used to improve the removing effect of particles and sludge.

In order to remove damages generated during the boring process and the machining process of the outer diameter and surface of the silicon electrode plate 140, an etching process is carried out. After etching, a cleansing process using DI or SCI is performed.

Thereafter, a donor killing process is carried out to stabilize resistance in the silicon electrode plate 140 (S155). Then, through a polishing process, the outer surface of the silicon electrode plate 140 is flattened and the surface roughness thereof is reduced, thereby silicon electrode (S156) is manufactured.

A double-sided polishing process is performed as the polishing process. Through the double-sided polishing process, the top and bottom surfaces of the silicon electrode plate 140 can be polished at the same time, and also the flatness of the top and bottom surfaces of the silicon electrode plate 140 can be improved.

After the double-sided polishing process, a cleansing process is performed to remove slurry and particles. In this way, a silicon electrode according to this embodiment is manufactured.

Then, a dimension of the completed silicon electrode is measured and a final cleansing process is carried out. After the final cleansing process, the silicon electrode is inspected with the naked eye in a dark room.

Of course, the silicon electrode according to this embodiment is not limited thereto. That is, if the whole diameter of the silicon electrode is larger than the diameter of the silicon core cylinder, a plurality of bodies can be used to manufacture the silicon electrode. For example, in a case where four pieces of bodies are combined and used to manufacture a silicon electrode, the aforementioned silicon electrode plate can be used to manufacture a body for the silicon electrode. That is, as shown in FIGS. 10 and 11, the silicon electrode plate 140 is processed into a shape of a silicon electrode body 140b. Then, a boring process is carried out to form a plurality of through-holes 141 in the silicon electrode body 140b. Thereafter, although not shown, a plurality of the silicon electrode bodies 140b are combined to manufacture a silicon electrode of desired size.

The aforementioned silicon ring and silicon electrode can be processed to have a kerf loss of 1 mm or less to reduce the production cost. In this embodiment, it is effective to process them with a kerf loss of 200 mm or less. They may be processed with a kerf loss of 10 to 200 mm.

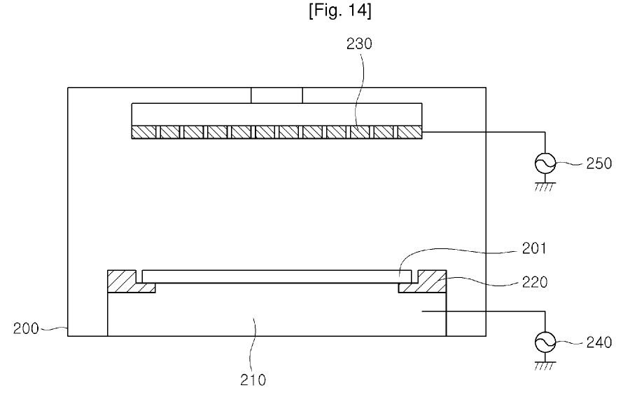

FIG. 14 is a schematic sectional view of a plasma etching apparatus in which the silicon articles manufactured according to the embodiment is employed.

The plasma etching apparatus is provided with a silicon ring 220 and a silicon upper electrode 230, which are manufactured according to the aforementioned method.

As shown in FIG. 14, the plasma etching apparatus includes a chamber 200, a lower electrode 210 on which a wafer 201 is seated, a silicon ring 220 provided in the edge area of the wafer 201 placed on the lower electrode 210, a silicon upper electrode 230 provided above the lower electrode 210 and integrated with a shower head, and first and second power supplies 240 and 250 for supplying electric power to the lower electrode 210 and the silicon upper electrode 230.

The silicon ring 220 allows the plasma to be uniform over the wafer 201, which is provided in the center of the ring. Furthermore, in this embodiment, the roughness of the top surface in the silicon ring 220 is made similar to that of the top surface in the wafer 201, thereby the uniformity of plasma can be further enhanced. Therefore, the etching uniformity in the edge area of the wafer can be improved. In addition, the lower electrode 210 can be prevented from being exposed to plasma and contaminated by the silicon ring 150. An electrostatic chuck may be employed as the lower electrode 210. The upper electrode 230 may be formed integrally with a shower head, which is supplied with and provides a reaction gas. In addition, the surface roughness of the silicon upper electrode 230 is made similar to that of the wafer, so that the plasma uniformity is enhanced and generation of particles is minimized.

The silicon ring 220 and the silicon upper electrode 230 manufactured according to this embodiment is not limited to the application to the aforementioned etching apparatus, but can be applied to various other types of plasma processing apparatuses.

It is described in the above that the silicon ring 220 is used as a focus ring for allowing plasma to be uniform over a wafer in the plasma processing apparatus. However, the silicon ring is not limited thereto, but can be used as a ring having various other functions according to processing of the inner and outer surfaces of the silicon ring 220. For example, the silicon ring can function as a fixing ring for fixing a substrate.

1. A method for manufacturing silicon articles, comprising:
preparing a silicon ingot;
forming a hollow silicon cylinder and a silicon core cylinder having a diameter less than that of the silicon ingot by coring the silicon ingot;
forming a silicon annular plate having a central opening by cutting the hollow silicon cylinder and forming a silicon electrode plate by cutting the silicon core cylinder; and
forming a silicon ring by processing the silicon annular plate and forming a silicon electrode by processing the silicon electrode plate.

2. The method as claimed in claim 1, further comprising removing a portion of both ends of the silicon ingot through a cropping process after preparing the silicon ingot.

3. The method as claimed in claim 1, further comprising processing an outer diameter of the silicon ingot through a rod grinding process after preparing the silicon ingot.

4. The method as claimed in claim 1, wherein the coring process is performed in such a way that a carbon jig is bonded to a top surface, a bottom surface, or both the top and bottom surfaces of the silicon ingot and a portion of the center of the silicon ingot to which the carbon jig is bonded is removed.

5. The method as claimed in claim 1, further comprising cutting the silicon ingot into a plurality of blocks before coring the silicon ingot.

6. The method as claimed in claim 1, wherein forming the silicon electrode comprises:
forming a plurality of through-holes by processing the silicon electrode plate; and
polishing surfaces of the silicon electrode plate having the through-holes.

7. The method as claimed in claim 6, wherein the through-hole is bored using a drill or ultrasonic wave.

8. The method as claimed in claim 7, wherein the silicon electrode plate is divided into a plurality of regions and the boring process is performed for each region.

9. The method as claimed in claim 6, further comprising processing the outer surface of the silicon electrode plate to adjust size thereof before or after forming the plurality of through-holes.

10. The method as claimed in claim 6, further comprising manufacturing a silicon electrode body by removing a portion of the silicon electrode plate before forming the plurality of through-holes.

11. The method as claimed in claim 10, further comprising manufacturing the silicon electrode by combining the silicon electrode bodies.

12. The method as claimed in claim 6, further comprising controlling resistance of the silicon electrode plate through a heat treatment process.

13. The method as claimed in claim 6, further comprising grinding the top and bottom surfaces of the silicon electrode plate simultaneously using a double-sided grinder after forming the plurality of through-holes.

14. The method as claimed in claim 6, wherein a double-sided polishing process for polishing the top and bottom surfaces of the silicon electrode plate simultaneously is used when polishing the surfaces.

15. A method for manufacturing silicon articles, comprising:
preparing a silicon cylinder;
forming a through-hole in the center of the silicon cylinder by a coring process;
forming a silicon annular plate having a central opening by cutting the silicon cylinder;
forming a silicon ring member by processing outer and inner surfaces of the silicon annular plate; and
polishing surfaces of the silicon ring member.

16. The method as claimed in claim 15, wherein preparing the silicon cylinder comprises:
growing a single crystal silicon ingot;
removing a portion of both ends of the single crystal silicon ingot using a cropping process; and
processing an outer diameter of the single crystal silicon ingot using a rod grinding process.

17. The method as claimed in claim 15, wherein the coring process comprises:
bonding a carbon jig to a top surface, a bottom surface, or the top and bottom surfaces of the silicon cylinder;
coring the silicon cylinder, to which the carbon jig is bonded, to partially remove a central portion of the silicon cylinder; and
removing the carbon jig and impurities generated during coring the silicon cylinder.

18. The method as claimed in claim 15, wherein a double-sided polishing process for polishing the top and bottom surfaces of the silicon ring member simultaneously is used when polishing the surfaces.

19. A method for manufacturing silicon articles, comprising:
preparing a silicon ingot;
forming a through-hole in a central portion of the silicon ingot; and
forming a silicon ring member by cutting the silicon ingot having the through-hole.

20. The method as claimed in claim 19, further comprising processing and polishing the silicon ring member.
